(19) United States
(12) Patent Application Publication
(10) Pub. No.: US 2018/0003345 A1
(43) Pub. Date: Jan. 4, 2018

(54) METAL HYDRIDE HYDROGEN STORAGE TANK COMPRISING A PLURALITY OF STACKED LEVELS

(71) Applicant: COMMISSARIAT A L'ENERGIE ATOMIQUE ET AUX ENERGIES ALTERNATIVES, Paris (FR)

(72) Inventors: Olivier GILLIA, Sassenage (FR); Albin CHAISE, Grenoble (FR)

(73) Assignee: COMMISSARIAT A L'ENERGIE ATOMIQUE ET AUX ENERGIES ALTERNATIVES, Paris (FR)

(21) Appl. No.: 15/536,753

(22) PCT Filed: Dec. 18, 2015
(86) PCT No.: PCT/EP2015/080529

§ 371 Date: Jun. 16, 2017

(30) Foreign Application Priority Data
Dec. 19, 2014 (FR) 14 62908

(51) Int. Cl. F17C 11/00

(52) U.S. Cl. CPC F17C 11/005; F17C 2270/0168; F17C 2227/0302; F17C 2201/0119; F17C 2205/0352; F17C 2205/0341; F17C 2221/012

(57) ABSTRACT

The invention relates to a tank for storing hydrogen by absorption into a hydrogen-storage material. The tank contains a chamber, a hydrogen feed inlet, a hydrogen discharge outlet, and an inner structure for storing the hydrogen-storage material. The inner structure contains a stack along a longitudinal axis of at least two levels for containing the storage material. Each level includes a distributor cup, a receiver cup for the storage material, and a collector cup. The distributor cups, receiver cups and collector cups are stacked one on top of the other and rigidly and sealingly connected to one another. The invention also relates to a distribution pipe distributing in parallel hydrogen in the distributor cups such that, for each level, hydrogen flows from each distributor cup to the collector cup by passing through the storage material.

### TECHNICAL FIELD AND PRIOR ART

The present invention relates to a metal hydride hydrogen storage tank offering improved hydrogen charging.

Alternative energies to oil are being sought due, notably, to the reduction in oil reserves. One of the promising vectors for these energy sources is hydrogen, which may be used in fuel cells for producing electricity.

Hydrogen is an element that is very widespread in the Universe and on Earth, it may be produced from natural gas or other hydrocarbons, but also by simple electrolysis of water using for example electricity produced by solar or wind energy.

Hydrogen fuel cells are already used in certain applications, for example in automobile vehicles but are still not very widespread, notably on account of the precautions that need to be taken and the difficulties for the storage of hydrogen.

Hydrogen may be stored in compressed form between 350 and 700 bars. It is then necessary to provide tanks capable of withstanding these pressures, knowing moreover that these tanks, when they are mounted in vehicles, may be subjected to impacts.

Hydrogen may be stored in liquid form, however this storage only ensures a low storage capacity and does not enable storage over long durations. The passage of a volume of hydrogen from the liquid state to the gaseous state under normal conditions of pressure and temperature produces an increase in its volume by a factor of around 800. Tanks of hydrogen in liquid form are not in general very resistant to mechanical impacts, which poses important problems of safety.

The so-called “solid” storage of hydrogen in hydride form also exists. This storage allows an important storage volume density and implements a moderate pressure of hydrogen while minimising the energy impact of the storage on the overall output of the hydrogen chain, i.e. from its production to its conversion into energy.

The principle of solid storage of hydrogen in hydride form is the following: certain materials and in particular certain metals have the capacity of absorbing hydrogen to form a hydride, this reaction is called absorption. The hydride formed may once again give gaseous hydrogen and a metal. This reaction is called desorption. Absorption or desorption occur as a function of the partial pressure of hydrogen and the temperature.

The absorption and desorption of hydrogen on a metal powder or matrix M takes place according to the following reaction:
Storage: heat released (exothermic)

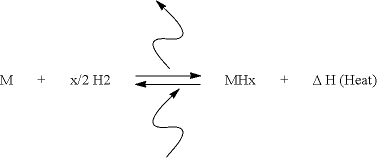

Destorage: Heat to be provided to (endothermic)
M being the metal powder or matrix,
MHx being the metal hydride.

For example a metal powder is used that is placed in contact with hydrogen, an absorption phenomenon arises and a metal hydride forms. The release of hydrogen takes place according to a desorption mechanism.

The storage of hydrogen is an exothermic reaction, i.e. which releases heat, whereas the release of hydrogen is an endothermic reaction, i.e. which absorbs heat.

Moreover, the material, in absorbing hydrogen, sees its volume increase.

When the material absorbs hydrogen, there is release of heat, the equilibrium pressure, that is to say the pressure above which the material is charged with hydrogen, increases, it rapidly reaches the hydrogen feed pressure, which has the effect of blocking the hydridation reaction. In order to combat this phenomenon, which is detrimental to rapid charging of the tank, it is necessary to cool the material. Conversely, in the sense of the release of hydrogen, an intake of heat has to take place in order to increase the equilibrium pressure and to have available a source of pressure above the pressure that it is wished to have at the tank outlet. Means are then provided for ensuring heat exchanges between the material inside the tank and a cold source or a hot source, depending on whether it involves a charge or discharge phase.

A first type of tank exists in which these heat exchanges are obtained by the implementation of the circulation of a heat transfer fluid, such as water, in a circuit sealingly separated from the hydride.

A second type of tank exists in which these heat exchanges are obtained using hydrogen directly as heat transfer fluid. Cooled hydrogen is injected into the hydrogen absorption phase. Part of the hydrogen injected is going to sweep a certain volume of the tank and is going to extract heat and is next going to come out of the tank to be cooled to be again reinjected into the tank. Potentially in desorption phase, heated hydrogen is injected into the tank of hydrogen contained in the hydrides. It is going to provide heat and is next going to come out of the tank to be heated or cooled in order to be again reinjected into the tank. In desorption phase, more hydrogen comes out of the tank than the quantity injected and in absorption phase less hydrogen comes out than the quantity injected. In general, the part of hydrogen desorbed or absorbed is low compared to the quantity of hydrogen injected into the tank with respect to thermal exchanges.

The document WO01/81850 describes an example of tank for storing hydrogen in hydride form in which the cooling in absorption phase is obtained by injecting hydrogen.

The inner structure of the tank comprises hydrogen storage plates arranged one on top of the other and channels between the plates enabling the flow of hydrogen between the plates in order to achieve convective cooling of the plates. Hydrogen is injected into the tank at the level of a first longitudinal end thereof and is collected at a second longitudinal end opposite to the first end. Hydrogen flows from the first longitudinal end, in the channels then to the second longitudinal end and comes out of the tank. The heat produced during absorption is produced within the hydride, the heat must thus reach the surfaces of the plates to be able to be discharged by the flow of hydrogen. The discharge of the heat is thus relatively slow, which reduces the absorption reaction kinetic. In order to increase the absorption kinetic, an important flow rate of hydrogen must be used.

### DESCRIPTION OF THE INVENTION

It is consequently an aim of the present invention to offer a hydrogen storage device with hydrogen as heat transfer fluid of simple construction and offering a substantially enhanced charge kinetic compared to devices of the prior art.

The aforementioned aim is attained by a tank for storage material comprising a chamber and an inner structure delimiting a plurality of levels in which is stored the hydrogen storage material in the form of bed, each level comprising upstream of the storage material, considering the sense of flow of hydrogen, a distribution zone for hydrogen in the storage material and downstream of the storage material a collector zone for hydrogen, so as to force hydrogen to pass through the bed of storage material over its whole thickness. A cooling or a heating at the core of the hydrogen storage material is thereby ensured. Moreover, the cooling or the heating is homogenous throughout the bed of hydrogen storage material. In addition, each of the levels is fed with hydrogen in parallel, thus all the beds are traversed by flows of hydrogen having substantially the same temperature and all the levels may exchange substantially the same quantity of heat.

In other words, the tank comprises a stratified inner structure comprising a distribution and collection network parallel to the hydrogen, forcing hydrogen to percolate through the pores of the granular medium formed by the storage material.

In an exemplary embodiment, the inner structure is formed of cups, each level comprising three cups, one for the hydrogen feed, one containing the hydrogen storage material and the other for the collection of hydrogen. Zones permeable to hydrogen enabling the circulation of hydrogen in the cup containing the hydrogen storage material and zones impermeable to hydrogen force hydrogen to pass through the hydrogen storage material.

It is thus ensured that almost all the hydrogen introduced into the tank enters into contact with the hydrogen storage material.

In another exemplary embodiment, the distribution zones are shared between a lower level and an upper level, as well as the collector zones.

The subject-matter of the present invention is a tank for storing hydrogen by absorption in a powder hydrogen-storage material, comprising:
a vessel,
at least one hydrogen feed inlet,
at least one hydrogen discharge outlet,
an inner structure for storing hydrogen-storage material, said inner structure comprising a stack along a longitudinal axis of at least two levels for containing storage material,

each level comprising a receiver zone for the storage material, a distributor zone for hydrogen and a collector zone for hydrogen situated on either side of the receiver zone along the longitudinal axis,

distribution means for distributing in parallel hydrogen in the distributor zones such that, for each level, hydrogen flows from each distributor zone to the collector zone by passing through the receiver zone for the storage material.

For example, the hydrogen distribution means in the distributor zones comprise a distribution pipe which is connected by a longitudinal end to the feed inlet and is closed at another longitudinal end, said distribution pipe passing through or edging all the zones and comprising openings emerging in the distributor zones.

The storage tank preferably comprises means connecting all the collector zones to the discharge outlet.

In an exemplary embodiment, each level comprises its distributor zone and its collector zone.

Each level may comprise a distributor cup, a receiver cup for the storage material and a collector cup, said distributor cups, receiver cups and collector cups being stacked one on top of the other in this order and rigidly and sealingly connected to one another.

For example, the receiver cup is tightly fitted into the distributor cup and the collector cup is tightly fitted into the collector cup. Also for example, the levels are tightly fitted into each other, the distributor cup of an upper level being tightly fitted into a collector cup of a lower level.

The distributor cup may comprise a bottom sealed to hydrogen and a lateral wall sealed to hydrogen and/or the receiver cup may comprise a bottom at least in part permeable to hydrogen and sealed to the powder storage material and a lateral wall sealed to hydrogen and/or the collector cup comprises a bottom at least in part permeable to hydrogen and a lateral wall sealed to hydrogen.

According to an additional characteristic, the means connecting the collector cups to the discharge outlet may comprise at least one longitudinal collector pipe passing through all the cups and comprising openings emerging in each of the collector cups.

Advantageously, the distribution pipe and/or the collector pipe comprise portions of pipes belonging to the distributor cups, to the receiver cups and to the collector cups, said portions of pipes being placed end to end during the stacking one on top of the other of the distributor cups, receiver cups and collector cups.

In another exemplary embodiment, the tank comprises one distributor zone for two levels and one collector zone for two levels.

The distributor zones may emerge in a longitudinal distribution pipe connected to the feed inlet and the collector zones may emerge in a peripheral channel delimited by the chamber and the inner structure, said peripheral channel being connected to the discharge outlet. Alternatively, the distributor zones may emerge in a peripheral channel delimited by the chamber and the inner structure, and the collector zones may emerge in a longitudinal distribution pipe connected to the discharge outlet said peripheral channel being connected to the feed inlet.

Preferably, the distributor zones and/or the collector zones comprise a structure permeable to hydrogen and forming a spacer between two bottoms of two successive receiver zones. Said structure is for example a porous material, a foam, a porous sintered material or comprises one or more grids.

The tank may comprise a stack in which alternate elements of a first type and elements of a second type, the elements of the first type and the elements of the second type being rigidly connected to one another, the distributor zones and the collector zones being formed between an element of the first type and an element of the second type.

For example, the elements of the first type and the elements of the second type comprise lateral walls sealed to hydrogen and bottoms at least permeable to hydrogen.

According to an additional characteristic, the elements of the first type and the elements of the second type may be sealingly connected to one another except at the level of the connections between the distributor zones and the distribution pipe and the connections between the collector zones and the collector channel. The elements of the first type and the elements of the second type may be fitted into each other and seals may be provided between the elements of the first type and the elements of the second type.

The elements of the first type and the elements of the second type may be advantageously made of a synthetic material, for example made of polymer material, for example polyamide.

Preferably, the levels are divided into at least parallelepiped cells of which the height, the width and the length are substantially equal.

Also preferably, the bottoms at least in part permeable to hydrogen may comprise filter cloth made of polymer material or metal.

Another subject-matter is a hydride tank comprising a tank according to the invention containing a hydrogen-storage material, for example a metal hydride.

Another subject-matter is an automobile vehicle comprising a propulsion system fed with hydrogen and a storage tank according to the invention connected to the propulsion system and means for heating the tank in desorption phase.

### BRIEF DESCRIPTION OF THE DRAWINGS

The present invention will be better understood by means of the description that follows and from the appended drawings in which:

FIG. 1 is a longitudinal sectional view of a first example of tank according to the invention,

FIG. 2 is a detailed view of FIG. 1,

FIG. 3 is a sectional view of an elementary stack of FIG. 1,

FIG. 4A is an isometric perspective view of the elementary stack of FIG. 3 in the absence of the collector cup,

FIG. 4B is an isometric perspective view of the elementary stack of FIG. 3 with the collector cup,

FIG. 5A is a detailed view of FIG. 1 represented schematically illustrating the operation of the tank,

FIG. 5B is a detailed view represented schematically of an alternative embodiment in which the longitudinal axis of the tank is oriented horizontally,

FIG. 6 is a longitudinal sectional view of a second exemplary embodiment of a tank according to the invention represented schematically,

FIG. 7 is a longitudinal sectional view of a practical embodiment of the tank according to the second exemplary embodiment in a horizontal configuration,

FIGS. 8A and 8B are detailed views of FIG. 7,

FIG. 9 is a schematic representation of an example of an absorption/desorption installation comprising a tank according to the invention.

### DETAILED DESCRIPTION OF PARTICULAR EMBODIMENTS

In the remainder of the description, metal hydrides will be designated by “storage material”.

In the description that follows, the tank(s) described have a cylindrical revolution shape, which represents the preferred embodiment. Nevertheless, any tank formed by a hollow element having a longitudinal dimension greater than its transversal dimension, and having any section, for example polygonal or ellipsoidal, does not go beyond the scope of the present invention.

Upstream and downstream are to be considered according to the sense of flow of hydrogen.

The terms “lower” and “upper” are to be considered with respect to the orientation of the drawings. As will be seen hereafter, the orientation of the tanks may be vertical, horizontal or other.

In FIGS. 1 to 5B may be seen a first exemplary embodiment of a hydrogen tank R1 according to the invention comprising a chamber 2 in which the storage material is stored. The chamber is formed of a ferrule 4 of longitudinal axis X closed at an upper end by an upper bottom 5 and closed at a lower end by a lower bottom 6. The ferrule 4 is, in the example represented, of circular section.

The chamber is intended to hold a certain pressure of hydrogen, typically comprised between 0.1 bar and 1000 bars.

In the example represented, the tank R1 comprises a hydrogen feed inlet 8 made in the lower bottom 6 and a hydrogen discharge outlet 10 made in the upper bottom 5.

The tank comprises an inner structure S1 ensuring both the confinement of the hydrogen storage material and the distribution and the collection of hydrogen within the material. The inner structure comprises several levels G1, G2, G3 . . . stacked one on top of the other along the direction X. Each level comprises a first, a second and a third zone arranged from upstream to downstream.

Each zone is delimited by a cup. The first zone is delimited by a distributor cup 12, the second zone is delimited by a receiver cup for the storage material 14, hereafter designated “hydride cup 14”, and the third zone is delimited by a collector cup 16.

The cups 12, 14, 16 are stacked one on top of the other and fitted into each other.

The hydride cup 14 is intended to contain the storage material M. It has a cylindrical shape with circular section. It comprises a lateral wall 14.1 sealed to hydrogen and to the storage material, a lower bottom 14.2 which is at least in part permeable to hydrogen and sealed to the powder storage material, a through central feed pipe 14.3 aligned with the longitudinal axis X and at least one through collector pipe 14.4 of axis parallel to the longitudinal axis X.

In the present application, it is considered that an element is sealed to the powder when the mass of powder lost while passing through the element is less than 1%.

The lateral wall 14.1 and the bottom 14.2 delimit a volume for containing storage material M. Advantageously, the volume is partitioned by means of partitions 18 so as to delimit advantageously cells having a ratio close to 1:1:1, i.e. a substantially equal height, width and length. The management of the phenomenon of swelling/deswelling of the hydride powder well known in the field of hydrogen storage during the absorption/desorption of hydrogen by the hydride is then facilitated, unlike containers having a too great slenderness ratio.

Preferably, the hydride cup 14 comprises several collector pipes 14.4, for example four pipes 14.4 in the example represented, enabling a uniform collection of hydrogen over the whole transversal section of the cup 14.

In the example represented in FIG. 4A, four partitions 18 surround the central pipe 14.3 and delimit a cell 20 of substantially square section, and four partitions 18 connect the four angles of the cell 20 to the lateral wall 14.1, delimiting four peripheral cells 20. Other delimitations of the volume may be envisaged.

The lower bottom 14.2 of the hydride cup 14 is for example formed by a cloth made of polymer or metal making it possible to retain the powder of the storage material but allowing hydrogen to pass through.

The collector cup 12 which is arranged upstream of the hydride cup 14 and in particular upstream of the lower bottom 14.2 of the hydride cup comprises a lateral wall 12.1 and a lower bottom 12.2 which are both sealed to hydrogen.

The lower bottom comprises a feed orifice 12.3 formed at the centre of the lower bottom 12.2 and at least one collector pipe 12.4. The collector tube 12.4 is arranged in the lower bottom 12.2 such that, when the hydride cup 14 is mounted on the distributor cup 12, each collector pipe 12.4 is aligned with a collector pipe 14.4. Preferably, the distributor cup 12 comprises as many collector pipes 12.4 as collector pipes 14.4. The connection between a collector pipe 12.4 and a collector pipe 14.4 is sealed to hydrogen.

The collector cup 16 arranged downstream of the hydride cup 14 comprises a lateral wall 16.1, a lower bottom 16.2, a central pipe 16.3 and at least one connection orifice 16.4. The connection orifice 16.4 is formed in the lower bottom 16.2 such that, when the collector cup 16 is mounted on the hydride cup 14, each connection orifice 16.4 is aligned with a collector pipe 14.4. The connection between a collector pipe 14.4 and the connection orifice 16.4 is sealed to hydrogen.

The collector cup 16 comprises as many connection orifices 16.4 as collector pipes 14.4 and 12.4.

The lower bottom 16.2 is permeable to hydrogen and sealed to the powder storage material so as to avoid powder being carried along with the flow of hydrogen.

The lateral wall 16.1 is sealed to hydrogen.

The lower bottoms 12.2, 14.2 and 16.2 have substantially the same external diameter. Preferably, the lateral wall 12.1 of the distributor cup 12 comprises a flared free end enabling the fitting of the bottom of the hydride cup 14. Preferably, the lateral wall 14.1 of the hydride cup 14 comprises a flared free end enabling the fitting of the bottom of the collector cup 16. Also preferably, the lateral wall 16.1 of the collector cup 16 comprises a flared free end enabling the fitting of the bottom of the distributor cup 12 of the upper level. Moreover, the lateral walls of the cups 12, 14, 16 have a dimension along the X axis greater than those of the feed channels and collector channels to enable fitting together.

Preferably, the flared free ends of the three cups have substantially the same external diameters.

The sealed parts are for example made of sheet metal. The collector and feed pipes are for example rigidly connected by crimping. The rigid connection between the sealed parts and the parts permeable to hydrogen is for example achieved by fitting together. In an alternative embodiment, the sealed parts may be made of polymer, for example polyamide.

The hydride cup may for example be produced by bonding or welding a filter cloth onto a plate pierced with holes or by arranging a filter cloth between two plates pierced with holes, the holes of the two plates coinciding.

The assembly of the cups will now be described.

The hydride cup 14 is fitted in the distributor cup 12 such that the feed orifice 12.3 is aligned with the feed pipe 14.3 and the collector pipe 12.4 is aligned with the collector orifice 14.4.

Next the collector cup is fitted in the free end of the hydride cup 12 such that the feed pipe 16.3 is aligned with the feed pipe 14.3 and the feed orifice 12.3 and such that the connection orifice 16.4 is aligned with the collector pipes 14.4 and 12.4. The lower bottom 16.2 of the collector cup 16 forms substantially a cover for the hydride cup 14.

The cups are advantageously tightly mounted together so as to ensure a fitting together substantially sealed to hydrogen to avoid leaks to the outside of the inner structure. The implementation of seals may then be avoided. In an alternative embodiment, the adjustment between the cups could not be tightened and seals could be used.

The storage material is put in place in the hydride cup 14 before putting in place the collector cup 16. It will be recalled that the hydride powder swells on absorption of hydrogen and deswells on desorption. In order to avoid that the hydride cups to not undergo too high loadings during swelling, it is preferable not to fill entirely the volume reserved for the hydride material. This volume is thus not entirely occupied by the material, and it generally forms a free surface.

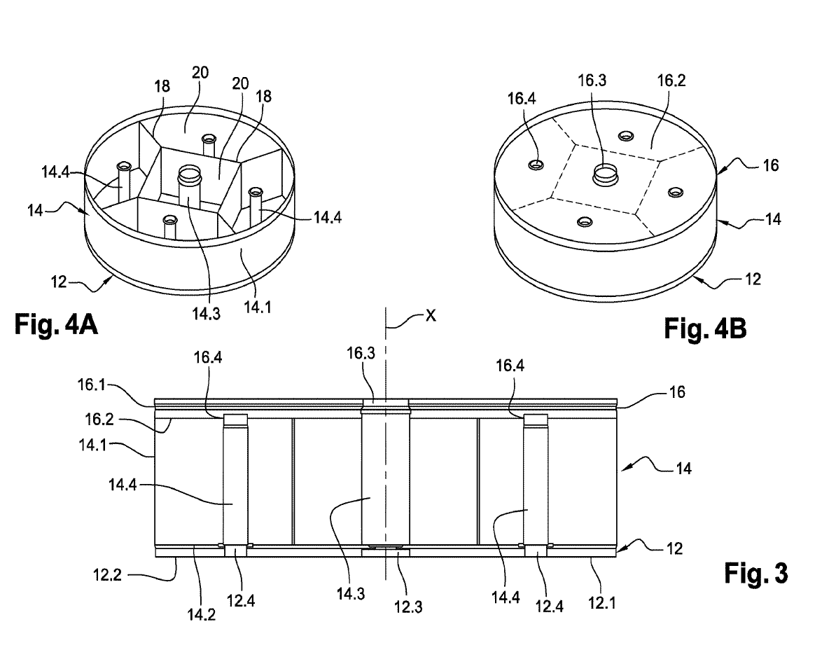

This stack is represented in FIGS. 3, 4A and 4B.

Each level may be assembled separately then the levels may be fitted into each other or then the cups are stacked and fitted into each other as the inner structure is assembled. The structure of the cups of the first exemplary embodiment makes it possible to only use three types of cup to produce the entire inner structure.

As a variant, it could be envisaged that the levels are produced separately by fitting together and that they are assembled together other than by fitting together.

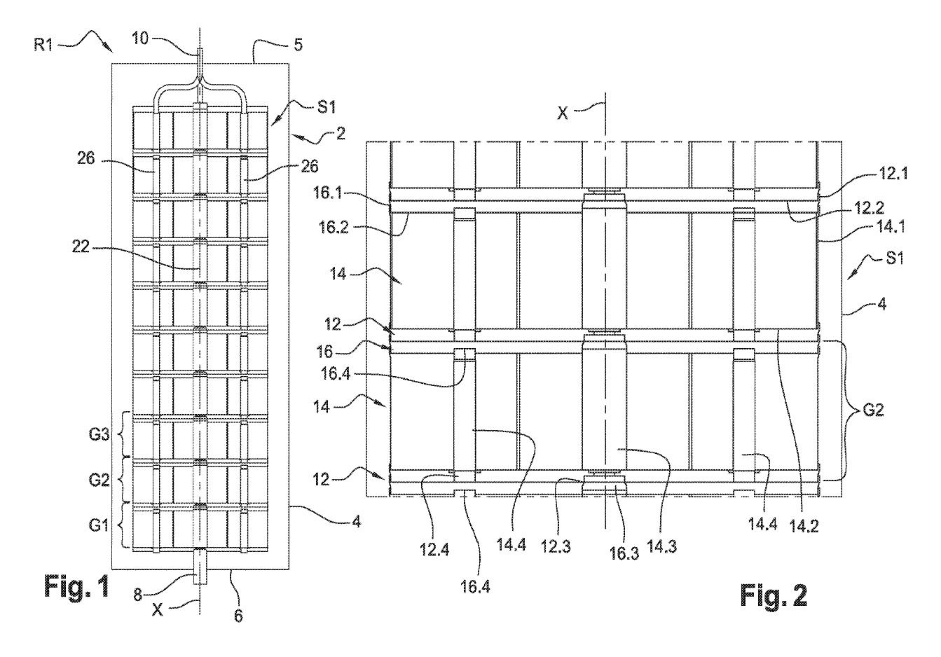

When all the levels are assembled, the inner structure comprises over its whole height a main central feed channel 22 provided with lateral openings 24 emerging in the distributor cups 12. The inner structure comprises at least one collector pipe 26, advantageously several collector pipes 26 over the whole height of the inner structure, the collector pipe 26 comprising lateral openings 28 emerging in the collector cups 16. The main feed pipes 22 and collector pipes 26 may be seen in FIG. 2.

The main feed channel 22 comprises an open longitudinal end 22.1 through which the channel 22 is fed with hydrogen, the lower end in the example represented.

The feed inlet 8 is intended to be connected to a source of pressurised hydrogen. Hydrogen injected into the tank goes around the stack, in the ferrule 4, to balance the pressures on either side of the walls 12.1, 14.1, 16.1. The main feed channel 22 also comprises a longitudinal end 22.2 closed, for example, by a plug 23, thus forcing hydrogen to flow into the distributor cups via the openings 24.

The collector pipes 26 comprise a longitudinal end connected to the discharge outlet 10 and an opposite longitudinal end sealed by plugs.

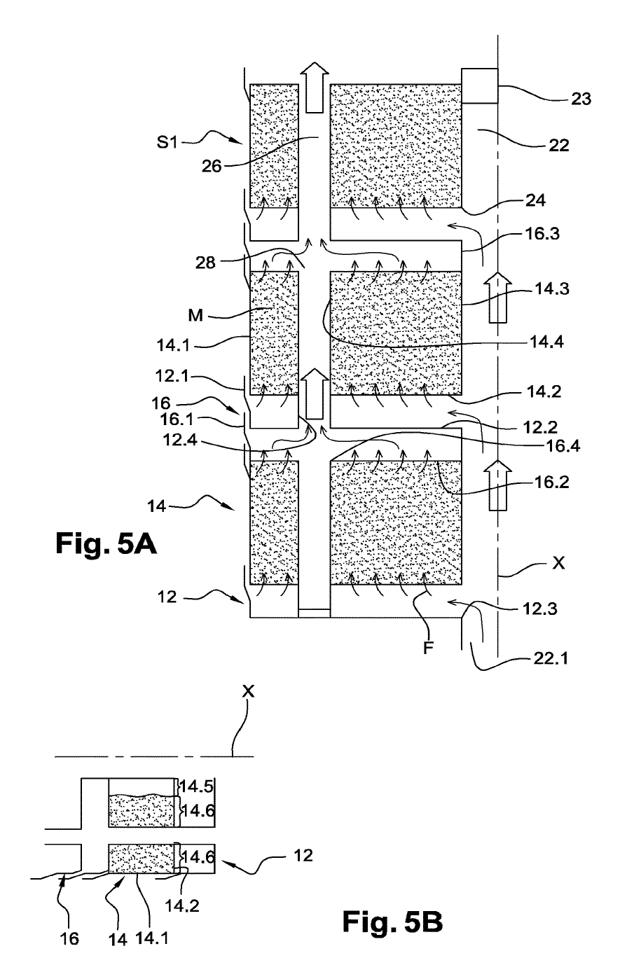

The tank of FIG. 1 may be used with its longitudinal axis X vertical, as is represented in FIG. 1. It may also be used with its longitudinal axis X oriented horizontally or any other intermediate orientation. In a horizontal orientation, the bottom of the bed of powder is formed by a part of the lateral wall 14.1 of the hydride cup 14 and the partitions 18. As is shown schematically in FIG. 5B, an upper part of the bottom 14.2 designated 14.5 is then not in contact with the powder. In order to avoid short-circuiting the storage material, only the part 14.6 of the bottom in contact with the storage material is made permeable to hydrogen. It may be envisaged that the permeable zone 14.6 has a uniform permeability over its whole surface or then has a permeability that decreases gradually in the direction of the free surface of the material.

The operation of the tank of FIG. 1 will now be described with the aid of FIG. 5A, the longitudinal axis X being oriented vertically.

In storage phase, i.e. absorption of hydrogen by the hydride, heat has to be extracted from the tank so as not to slow down the kinetic of absorption, cooled hydrogen is introduced into the tank, for example between −50° C. and 400° C. Hydrogen feeds the tank via the feed inlet 8, the flow rate is such that it enables, on the one hand, to supply hydrogen which will be stored in the hydride and, on the other hand, to supply the flow of heat transfer fluid making it possible to extract calories from the hydride.

The flow of hydrogen, symbolised by the arrows F, flows in the main feed pipe 22 then into each of the distributor cups 12 via the lateral openings 24. The lower bottoms 12.2 of the distributor cups 12 being sealed to hydrogen, and the lateral walls 12.1 and the lower bottoms 14.2 of the hydride cups being permeable to hydrogen, hydrogen passes through the lower bottoms 14.2 of the hydride cups 14. The passage of hydrogen takes place in a spread out and homogenous manner through the lower bottom 14.2. Hydrogen next percolates into the porous medium formed by the hydride powder over its whole thickness then re-exits through the lower bottom 16.2 of the collector cups 16. It is recalled that the lateral walls 14.1 are also sealed to hydrogen.

The lower bottom 12.2 of the distributor cup 12 of the upper level being sealed to hydrogen, hydrogen collected at the lower level circulates in the collector pipes 26 and next comes out via the discharge outlet 10. The quantity of hydrogen collected is less than that injected on account of the absorption, and the flow of hydrogen has seen its temperature increase due to thermal exchanges.

In de-storage phase, i.e. desorption of hydrogen by the hydride, in a preferred manner a reheating of the hydride by the exterior is provided, for example by means of a resistance surrounding the ferrule or a circuit of heat transfer fluid, as will be described below.

Nevertheless, it may be envisaged to inject heated hydrogen into the tank, for example between 0° C. and 500° C. The circulation of hydrogen is identical to that in storage phase. The quantity of hydrogen collected is greater than that injected on account of the desorption and the flow of hydrogen has seen its temperature decrease due to heat exchanges.

The distribution of hydrogen at each level and the collection of hydrogen at each level thus take place in parallel.

A circulation of heat transfer fluid is obtained at the very core of the storage material thereby ensuring heating or cooling at the core of the storage material. The reaction kinetic is thus improved.

Moreover, hydrogen is distributed in a homogenous manner to all of the levels of the inner structure, and at substantially the same temperature. Consequently, the absorption and desorption reactions have a substantially identical kinetic at all the levels of the structure, unlike a tank in which it is the same heat transfer fluid which circulates through all the levels.

Furthermore, the powder of the storage material is confined between the hydride cups and the collector cups preventing the powder from being carried along by the flow of hydrogen.

As an example, for an application on board for example a tractor, the diameter of the cups may be equal to 200 mm. The elements 12 and 16 measure 4 mm high. The elements 14 measure 60 mm high. For example 15 cups are stacked.

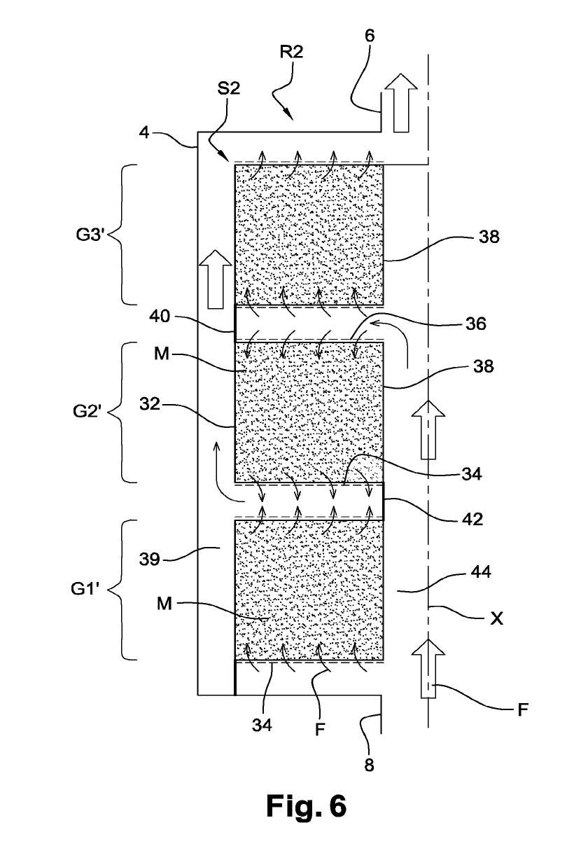

In FIGS. 6 to 8B may be seen another exemplary embodiment of a tank R2 which differs from that of FIGS. 1 to 5B in that the general collection of hydrogen takes place between the inner structure and the inner face of the ferrule.

The inner structure S2 also comprises several levels G1′, G2′, G3′, . . . stacked one on top of the other along the longitudinal axis X. A distribution zone 30 is provided between two levels and every two levels such that a distribution zone distributes hydrogen in two levels simultaneously. A collector zone 30 is provided between two levels every two levels, such that a collector zone 30 collects hydrogen from two levels simultaneously.

In the representation of FIG. 6, each level comprises a lateral wall 32, a lower bottom 34, an upper bottom 36 and a central pipe 38. The lateral wall 32 and the central pipe are sealed to hydrogen and the lower 34 and upper 36 bottoms are at least in part permeable to hydrogen and sealed to the powder of the storage material.

The lateral walls define with the ferrule a collector channel 39.

The upper bottom 36 of a level is maintained at a distance from a lower bottom 34 of the upper level to delimit either a collector zone or a distributor zone.

Each distributor zone comprises a lateral wall 40 between two successive levels and each collector zone comprises a cylindrical wall 42 between two successive levels.

Thus, the inner structure comprises a main central feed pipe 44 comprising orifices 46 emerging in the distributor zones every two levels, and the inner structure comprises collector orifices 48 emerging in the collector channel 39.

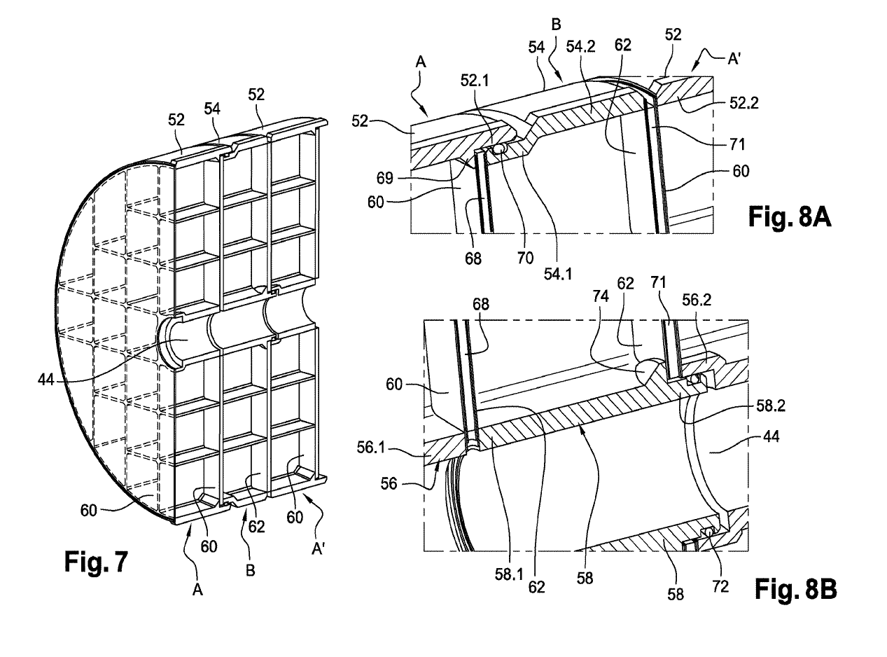

In FIGS. 7 and 8A and 8B may be seen a practical exemplary embodiment of the tank of FIG. 6.

Advantageously, each level is compartmentalised into cells, for example of parallelepiped section for the most part. Advantageously, the ratio 1:1:1 between the different dimensions of the cells is respected.

In the example represented, the inner structure S2 comprises a stack of at least two distinct elements A and B fitting into each other so as to obtain an alternation of feed orifices on the side of the central pipe and collector orifices on the side of the collector channel 39.

The element A comprises a radially external wall 52 of which a first longitudinal end 52.1 cooperates in a sealed manner with a first longitudinal end 54.1 of the radially external wall 54 of the element B. The element A comprises a radially internal wall 56 which cooperates with a radially internal wall 58 of the element B, so as to arrange between a first longitudinal end 56.1 of the radially internal wall 56 and a first longitudinal end 58.1 of the radially internal wall 58 facing the end 56.1, a clearance enabling hydrogen to flow into the central pipe to access a distribution zone arranged between two bottoms facing the elements A and B.

The element A comprises bottoms 60 and the element B comprises bottoms 62 at least in part permeable to hydrogen and sealed to the powder of the storage material. The bottoms are for example made of filter cloth, said cloth is for example bonded or thermo-welded onto the pieces 52 and 54.

Advantageously, a thick, rigid piece 68 permeable to hydrogen is arranged in the distribution zone. It makes it possible to conserve the thickness of the distribution zone by forming a spacer between the bottoms 60, 62 of the elements A and B so as to maintain the circulation of hydrogen. Moreover, its rigidity makes it possible to protect the filter cloth of the bottoms against swelling of the storage material.

The piece 68 may be made of porous sintered material, a porous material or comprise one or more grids made of synthetic material, of polymer or metal type, or foam or sintered material with open porosity. The piece 68 may not be sealed to the powder since the bottoms of the elements retain the powder. In an alternative embodiment, the filter cloth could be omitted, the piece 68 is then configured to retain the powder and to be permeable to hydrogen, and to guarantee sealing to the powder at the level of the contacts with the pieces 52 or 54.

In the example represented, the piece 68 is received between a shoulder 69 formed in the inner face of the radially external wall 52 of the element A and the first end 54.1 of the element B and between the ends 56.1 and 58.1.

A seal 70, for example an O-ring, may advantageously be provided between the first ends 52.1 and 54.1 to strengthen the sealing. In the example represented, the seal 70 is mounted in a groove of the first end 54.1.

The second longitudinal ends of the elements A and B, opposite to those on the side of the distribution zone, enable hydrogen to come out of the elements A and B after having passed through the storage material M.

In the case of a stack of two elements A and B, the two elements are fed with hydrogen via the distribution zone and hydrogen is evacuated via the free longitudinal ends of the elements A and B.

In the case of a stack of more than two elements A and B, for example of two elements A, and one element B (the second element A will be designated A′ for reasons of clarity) as is represented in FIGS. 6 to 8B, the second longitudinal end 54.2 of the radially external wall of the element B opposite to the first longitudinal end 54.1 cooperates with a second end 52.2 of the radially external wall of an element A′. A space is thus arranged between the second longitudinal ends 54.2, 52.2 and the collector and discharge zone is delimited between the bottoms of the elements. The second ends 56.2, 58.2 of radially inner walls sealingly cooperate. A seal 72, for example an O-ring, may advantageously be provided to strengthen the sealing. In the example represented, the seal 72 is mounted in a groove of the second end 58.2 of the radially inner wall 58 of the element B.

As for the distribution zone, a thick and rigid piece 71 permeable to hydrogen may be arranged in the collector and discharge zone. It makes it possible to conserve the thickness of the collector and discharge zone while forming a spacer between the bottoms of the elements A and B so as to maintain the circulation of hydrogen. Moreover its rigidity makes it possible to protect the filter cloth of the bottoms against swelling of the storage material.

The piece 71 may be made of a porous material, sintered porous material or comprise one or more grids made of synthetic material, of polymer or metal type or foam. The piece 71 may not be sealed to the powder since the bottoms 60, 62 of the elements A and B retain the powder. As for the piece 68, the piece may be configured to be able to omit the filter cloth.

In the example represented, the piece 71 is maintained tightened between a shoulder 74 formed in the inner face of the radially inner wall 58 of the second element B and the second end 56.2 of the radially inner wall 56 of the element A′ and between the ends of the radially inner walls of the element B and of the element A′.

The stack of elements A and B may be continued. The inner structure thereby formed comprises distribution zones common to the two elements A and B and collector and discharge zones common to two elements A and B except at the level of the ends.

As is shown schematically in FIG. 6, the central pipe 44 is connected by one end to the hydrogen feed and is sealed at the opposite longitudinal end to force hydrogen to penetrate the distribution zones.

For example and advantageously, the elements A, B, A′ are made of synthetic material, such as polymer, for example polyamide, which simplifies their manufacture, for example by moulding.

The operation of the tank according to the second exemplary embodiment will now be described. The charge and discharge phases will not be distinguished. The flow is symbolised by the arrows F.

The central pipe is fed with hydrogen, hydrogen penetrates into the distribution zones between two cells, it flows into the piece 68 and flows into the cells A and B, it percolates through the storage material and discharges into the peripheral channel via the collector and discharge zones. The peripheral channel is connected to the discharge outlet. Depending on whether it is in charge or discharge, the hydrogen injected has been cooled or heated beforehand.

A tank according to the second exemplary embodiment may be manufactured as follows:

Firstly elements A and B are manufactured for example by moulding, one of the bottoms formed of filter cloth may be arranged in the moulds before moulding. Seals 70, 72 are next put in place on the element B. It will be understood that the seals could be borne by the element A uniquely or one by the element A and the other by the element B. Furthermore, it could be envisaged that the seals are overmoulded during the moulding of the elements A and B.

If the stack rests on an element A, the element A is filled with powder, the quantity of powder put in place takes account of the swelling.

Next, a filter cloth closes the open end of the element A. The filter cloth may be bonded, thermo-bonded or only placed, the whole of the stack being compressed thereafter, said cloth then being pressed against the piece A by the piece 68. Then a piece 68 is arranged on the filter cloth. An element B is next arranged on the piece 68 and is fitted into the radially external wall of the element A. The element B is filled with powder. A filter cloth closes the open end of the element B and a piece 71 is arranged on the filter cloth. Another element A is fitted into the element B and the steps are repeated until the desired number of levels is reached.

The upper longitudinal end of the central pipe is closed in a sealed manner to hydrogen. The inner structure thereby formed is mounted inside the ferrule and rests on the lower bottom. The open end of the central pipe 44 is connected to the feed inlet 8. The peripheral channel 39 is connected to the discharge outlet 10.

As an example uniquely, values of dimensions of the elements of the tank R2 will be given. The elements A and B may comprise parallelepiped cells of 1 cm to 20 cm sides, containing the hydride. The pieces 68 and 71 have for example a thickness comprised between 0.2 mm to 10 mm. The diameter of the elements A and B is comprised between 20 mm and 500 mm, for example 200 mm. The number of stacked elements may be comprised between 2 and 100 elements, typically 10.

The tank according to the second example enables a parallel and almost simultaneous distribution in all the elements of hydrogen and a thermal exchange with hydrogen at the core of the storage material.

In the two examples described, the elements and cups are fitted together but it will be understood that it could be envisaged to rigidly connect the elements and cups together, for example by clipping links, by bayonet links or even by external mechanical means. The inner structure may then be more easily handled.

It will be understood that the two exemplary embodiments may be combined. For example it may be envisaged in the tank of the first exemplary embodiment that the collector cups 16 emerge in a peripheral channel, which would make it possible to delete the collector pipes passing through all the levels.

In the first exemplary embodiment, inner pipes with a common distributor volume and a collector volume common to two hydride cups may be envisaged.

Moreover, in the two exemplary embodiments the sense of flow of hydrogen may be reversed. In the first exemplary embodiment, the feed could be from above and in the second exemplary embodiment it could be envisaged to feed via the peripheral channel and collecting by the central pipe.

Thanks to the invention, hydrogen passes through the volume of hydride and exchanges directly in contact with the grains of the storage material, which reduces the thermal gradients because the heat of reaction is driven only over the length of a grain of powder. Moreover, the exchange with the gas takes place over a very large surface, which is the specific surface of the powder.

For example, for powder of which the grains have a diameter less than 0.1 mm, it may be considered that the gas is locally at the same temperature as the powder.

For example, during filling of the tank, the grains have a size comprised between 0.1 μm and 5 mm. During operation, the absorption-desorption cycling of hydrogen leads to a so-called decrepitation phenomenon, that is to say that the grains naturally break up into smaller grains, the phenomenon taking place in the first hydridation cycles and continues to diminish bit by bit.

The equilibrium size of the grains depends on the hydride material, typically it is micrometric.

During filling of the tanks, it is possible to envisage using blocks of hydride which are going to be transformed into powder as the charges and discharges progress due to the phenomenon of decrepitation. The kinetic of the tank will then be very slow at the start and the tank will only be useable after a certain number of cycles, this phase is commonly called activation phase.

The metal hydrides implemented are for example TiVCr TiVMn, LaNi₅, TiFe, TiCrMn, TiVCrMo, Mg₂Ni, TiFeMn, LiBH₄+MgH₂, NaAlH₄, Mg, KSi, etc.

In addition, the storage material is placed in a cell permeable to the gas and impermeable to the powder.

Furthermore, the hydrogen distribution system making it possible to reach all the storage material is relatively compact.

The second exemplary embodiment has the advantage that hydrogen heated or cooled after having passed through the storage material circulates outside of the stack whereas according to the first example it circulates within the stack in the collector pipes. Moreover, the system is simplified since the number of different pieces is reduced. In addition, the tank according to the second example is more compact.

The tank according to the invention may advantageously be applied to the storage of hydrogen on board heavy machinery, of tractor type.

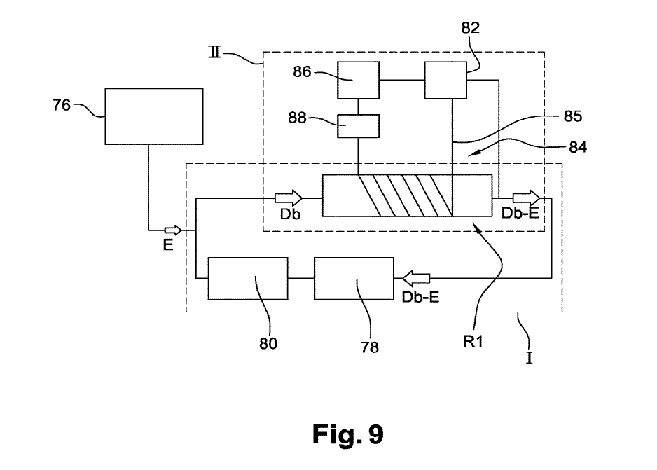

In FIG. 9 may be seen a schematic representation of an example of installation making it possible to charge the tank with hydrogen and making it possible to discharge this hydrogen for example to a hydrogen cell.

The installation comprises the tank according to the invention, for example the tank R1, a high pressure hydrogen feed 76 connected to the orifice 8 of the tank R1.

It comprises in a first absorption loop I a heat exchanger 78 and a recirculation 80 connected to the outlet of the tank R1.

It comprises in a second desorption loop II a device consuming hydrogen, for example a fuel cell 82.

The installation also comprises means for heating 84 the tank. Advantageously, they are formed by a heat transfer fluid heated by the fuel cell in operation and a circuit 85 in contact with the shell of the tank R1 to reheat the hydrides. A pump 86 is provided for the circulation of the heat transfer fluid and a radiator 88. Advantageously, the heat transfer fluid is formed of hydrogen.

The second loop II is for example on board a vehicle.

The operation of the installation is the following.

In absorption phase, a flow rate Db of cold hydrogen enters into the tank R1; this flow is directed towards the hydrides contained in the tank R1; a part ε of the hydrogen is absorbed by the hydrides which heat up; the remaining part of the hydrogen Db-ε heats up on contact with the hydrides and cools them, then comes out of the tank R1. Hydrogen next passes into the heat exchanger 78 to be cooled then into the circulator 80 and recommences the circuit of loop I. This loop I is fed with hydrogen by a high pressure feed 76 to compensate the part of gas absorbed by the hydrides and to increase the pressure throughout the loop I. Hydrogen is both the heat transfer fluid and the gas to store.

In desorption phase, once the tank R1 pressurised and the hydrides charged with hydrogen, the tank R1 is disconnected from the loop I to feed the fuel cell 82. The heat from the fuel cell is directed to the tank R1 to supply the heat of desorption by a liquid heat transfer fluid, then to the radiator 88 then to a pump 86.

1. A storage tank for storing hydrogen by absorption into a powder hydrogen-storage material, comprising:
a vessel,
at least one hydrogen feed inlet,
at least one hydrogen discharge outlet, and
an inner structure for storing the hydrogen-storage material,
wherein
said inner structure comprises a stack along a longitudinal axis of at least two levels for containing the storage material,
each level comprises a receiver zone for the storage material, a distributor zone for hydrogen, and a collector zone for hydrogen situated on either side of the receiver zone along the longitudinal axis, and
at least one hydrogen distributor distributes in parallel hydrogen in the distributor zones such that, for each level, hydrogen flows from each distributor zone to the collector zone by passing through the receiver zone for the storage material.

2. The storage tank according to claim 1, wherein
the hydrogen distributor comprises a distribution pipe which is connected by a longitudinal end to the hydrogen feed inlet and is closed at another longitudinal end, and
said distribution pipe passes through or edges all the zones and comprises openings emerging in the distributor zones.

3. The storage tank according to claim 1, comprising at least one connector connecting all the collector zones to the hydrogen discharge outlet.

4. The storage tank according to claim 1, wherein each level comprises a distributor zone and a collector zone.

5. The storage tank according to claim 4, wherein
each level comprises a distributor cup, a receiver cup for the storage material, and a collector cup, and
the distributor cups, receiver cups and collector cups are stacked one on top of the other in this order and rigidly and sealingly connected to one another.

6. The storage tank according to claim 5, wherein the receiver cup is tightly fitted into the distributor cup and the collector cup is tightly fitted into the receiver cup.

7. The storage tank according to claim 5, wherein the levels are tightly fitted into each other, and the distributor cup of an upper level is tightly fitted into the collector cup of a lower level.

8. The storage tank according to claim 5, wherein
the distributor cup comprises a bottom sealed to hydrogen and a lateral wall sealed to hydrogen,
the receiver cup comprises a bottom at least in part permeable to hydrogen and sealed to the powder storage material and a lateral wall sealed to hydrogen, and
the collector cup comprises a bottom at least in part permeable to hydrogen and a lateral wall sealed to hydrogen.

9. The storage tank according to claim 5, comprising
at least one connector connecting all the collector zones to the discharge outlet,
wherein the connector comprises at least one longitudinal collector pipe passing through all the cups and comprising openings emerging in each of the collector cups.

10. The storage tank according to claim 2, wherein
the at least one hydrogen distributor comprises a distribution pipe which is connected by a longitudinal end to the hydrogen feed inlet and is closed at another longitudinal end, said distribution pipe passing through or edging all the zones and comprising openings emerging in the distribution zones, and
the distribution pipe and/or the collector pipe comprise portions of pipes belonging to the distributor cups, to the receiver cups, and to the collector cups, said portions of pipes being placed end to end during the stacking one on top of the other of the distributor cups, the receiver cups and the collector cups.

11. The storage tank according to claim 1, comprising a distributor zone for two levels and a collector zone for two levels.

12. The storage tank according to claim 11, wherein
the distributor zones emerge in a longitudinal distribution pipe connected to the hydrogen feed inlet, and
the collector zones emerge in a peripheral channel delimited by the vessel and the inner structure, said peripheral channel being connected to the hydrogen discharge outlet.

13. The storage tank according to claim 12, wherein
the distributor zones emerge in the peripheral channel delimited by the vessel and the inner structure, and
the collector zones emerge in the longitudinal distribution pipe connected to the hydrogen discharge outlet, said peripheral channel being connected to the hydrogen feed inlet.

14. The storage tank according to claim 11, wherein the distributor zones and/or the collector zones comprise a structure permeable to hydrogen and forming a spacer between two bottoms of two successive receiver zones.

15. The storage tank according to claim 14, wherein said structure is a porous material, a foam, a porous sintered material or comprises one or more grids.

16. The storage tank according to claim 12, comprising a stack in which alternate elements of a first type of element and elements of a second type of element,
wherein
the elements of the first type and the elements of the second type are rigidly connected to one another, and
the distributor zones and the collector zones are formed between an element of the first type and an element of the second type.

17. The storage tank according to claim 16, wherein the elements of the first type and the elements of the second type comprise lateral walls sealed to hydrogen and bottoms at least permeable to hydrogen.

18. The storage tank according to claim 16, wherein the elements of the first type and the elements of the second type are rigidly and sealingly connected to one another except at the level of the connections between the distributor zones and the distribution pipe and the connections between the collector zones and the collector channel.

19. The storage tank according to claim 18, wherein the elements of the first type and the elements of the second type are fitted into each other and seals are provided between the elements of the first type and the elements of the second type.

20. The storage tank according to claim 16, wherein the elements of the first type and the elements of the second type are made of a synthetic material.

21. The storage tank according to claim 1, wherein the levels are divided into at least parallelepiped cells of which the height, the width and the length are substantially equal.

22. The storage tank according to claim 8, wherein the bottoms at least in part permeable to hydrogen comprise filter cloth made of polymer material or metal.

23. The storage tank according to claim 1, containing a metal hydride.

24. An automobile vehicle, comprising
a propulsion system fed with hydrogen and
the storage tank according to claim 23 connected to the propulsion system and a heater for heating the tank in desorption phase.

25. The storage tank according to claim 16, wherein the elements of the first type and the elements of the second type are made of polymer material.
